(19) United States
(12) Patent Application Publication
(10) Pub. No.: US 2026/0358275 A1
(43) Pub. Date: Nov. 12, 2026

(54) Method of Operating a Spectrometer

(71) Applicant: University of Washington, Seattle, WA (US)

(72) Inventors: Gerald Todd Seidler, Seattle, WA (US); Anthony Gironda, Seattle, WA (US)

(21) Appl. No.: 19/490,705

(22) PCT Filed: Jun. 27, 2024
(86) PCT No.: PCT/US2024/035709

§ 371 Date: Dec. 5, 2025

Related U.S. Application Data
(60) Provisional application No. 63/510,518, filed on Jun. 27, 2023.

(51) Int. Cl. G01N 23/207; G01N 23/085; G01N 23/223

(52) U.S. Cl. CPC G01N 23/2076; G01N 23/085; G01N 23/223

(57) ABSTRACT

A method of operating a spectrometer includes positioning a crystal analyzer such that a first reciprocal lattice vector corresponding to a first crystal plane of the crystal analyzer is coplanar with a source axis and a detector axis, and performing a first scan by varying a first angle between the source axis and the first crystal plane and varying a second angle between the detector axis and the first crystal plane such that the first angle is substantially equal to the second angle, rotating the crystal analyzer such that a second reciprocal lattice vector corresponding to a second crystal plane of the crystal analyzer is coplanar with the source axis and the detector axis, and performing a second scan by varying the first angle and varying the second angle such that the first angle is substantially equal to the second angle.

### CROSS-REFERENCE TO RELATED APPLICATION

This application claims priority to U.S. Provisional Patent Application No. 63/510,518, filed on Jun. 27, 2023, the entire contents of which are incorporated by reference herein.

### STATEMENT REGARDING FEDERALLY SPONSORED RESEARCH OR DEVELOPMENT

This invention was made with government support under Grant No. DE-NE0009158, awarded by the U.S. Department of Energy. The government has certain rights in the invention.

### BACKGROUND

Many x-ray spectrometers use a curved crystal analyzer (CCA) as a type of monochromator to selectively scatter x-rays that are emitted from, or transmitted through, a material sample under test. A CCA is typically fabricated by gluing or bonding a silicon or germanium wafer to a concave glass lens or other concave form. The crystallographic orientation of the wafer surface is chosen so that the lattice spacing of crystal planes nominally parallel to the surface is appropriate, via Bragg's law, to generate constructive interference of x-rays within the energy or wavelength range of interest. However, using the same spectrometer to investigate a sample's response within a different energy or wavelength range generally requires using a second CCA. The second CCA is selected such that the crystal planes nominally parallel to the surface of the second CCA have a lattice spacing that is different from the lattice spacing of the original CCA. Swapping CCAs out of a spectrometer to investigate different wavelength or energy ranges can be tedious and time-consuming.

### SUMMARY

A first example is a method of operating a spectrometer comprising a crystal analyzer that defines a Rowland circle, a source configured to emit x-rays along a source axis, and a detector configured to detect x-rays travelling along a detector axis, the method comprising: positioning the crystal analyzer such that a first reciprocal lattice vector corresponding to a first crystal plane of the crystal analyzer is coplanar with the source axis and the detector axis; performing, while the first reciprocal lattice vector is coplanar with the source axis and the detector axis, a first scan by varying a first angle between the source axis and the first crystal plane and varying a second angle between the detector axis and the first crystal plane such that the first angle is substantially equal to the second angle; rotating the crystal analyzer such that a second reciprocal lattice vector corresponding to a second crystal plane of the crystal analyzer is coplanar with the source axis and the detector axis; and performing, while the second reciprocal lattice vector is coplanar with the source axis and the detector axis, a second scan by varying the first angle and varying the second angle such that the first angle is substantially equal to the second angle.

A second example is a non-transitory computer readable medium storing instructions that, when executed by one or more processors of a spectrometer, cause the spectrometer to perform the method of the first example.

A third example is a spectrometer comprising: a source configured to emit x-rays along a source axis; a detector configured to detect x-rays travelling along a detector axis; an analyzer stage configured to hold a crystal analyzer that defines a Rowland circle, wherein the analyzer stage is configured to rotate the crystal analyzer about an analyzer axis that is coplanar with the source axis and the detector axis; and an alignment apparatus comprising: a source stage that is configured to hold the source; a detector stage that is configured to hold the detector; and a goniometer configured to (i) adjust a fifth angle between the analyzer stage and the detector axis and (ii) adjust a sixth angle between the analyzer stage and the source axis, wherein the alignment apparatus is configured to move the source stage, the detector stage, and/or the analyzer stage to adjust a first distance between the source and the analyzer stage along the source axis and adjust a second distance between the detector and the analyzer stage along the detector axis.

The contents of the following documents are incorporated by reference herein: Anthony J. Gironda et al., “Asymmetric Rowland circle geometries for spherically bent crystal analyzers in laboratory and synchrotron applications.” J. Anal. At. Spectrom., 2024, 39, 1375. https://pubs.rsc.org/en/content/articlelanding/2024/ja/d3ja00437f.

When the term “substantially” or “about” is used herein, it is meant that the recited characteristic, parameter, or value need not be achieved exactly, but that deviations or variations, including, for example, tolerances, measurement error, measurement accuracy limitations, and other factors known to those of skill in the art may occur in amounts that do not preclude the effect the characteristic was intended to provide. In some examples disclosed herein, “substantially” or “about” means within +/−0-5% of the recited value.

These, as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate the invention by way of example only and, as such, that numerous variations are possible.

### BRIEF DESCRIPTION OF THE DRAWINGS

FIG. 1 is a block diagram of a spectrometer, according to an example.

FIG. 2 is a schematic diagram of a spectrometer configured for operation in an asymmetric mode, according to an example.

FIG. 3A is a schematic diagram of a spectrometer configured for performing an x-ray absorption fine structure (XAFS) scan, according to an example.

FIG. 3B is a schematic diagram of a spectrometer configured for performing an x-ray emission spectroscopy (XES) scan, according to an example.

FIG. 4A is a schematic diagram of an analyzer stage and a crystal analyzer, according to an example.

FIG. 4B is a schematic diagram of an analyzer stage and a crystal analyzer, according to an example.

FIG. 4C is a schematic diagram of an analyzer stage and a crystal analyzer, according to an example.

FIG. 5 is a schematic diagram of a spectrometer configured for operation in an asymmetric mode, according to an example.

FIG. 6 is a block diagram of a method, according to an example.

FIG. 7A is a schematic diagram of a spectrometer configured for operation in a symmetric mode, according to an example.

FIG. 7B is a schematic diagram of a spectrometer configured for operation in an asymmetric mode, according to an example.

FIG. 8A shows the degree of Johann error based on location of x-ray incidence on the crystal analyzer during operation in the symmetric configuration, according to an example.

FIG. 8B shows the degree of Johann error based on location of x-ray incidence on the crystal analyzer during operation in the asymmetric configuration, according to an example.

FIG. 9 shows calculated values and experimental results for (α,φ) corresponding to several crystal planes of the Si(551) crystal analyzer, according to an example.

### DETAILED DESCRIPTION

A need exists for a method of operating a spectrometer that does not require using different curved crystal analyzers (CCAs) when investigating a sample's response within a wide wavelength or energy range. Accordingly, this disclosure includes such spectrometers and methods of operation.

A spectrometer includes a source such as an x-ray tube configured to emit x-rays along a source axis and a detector such as a silicon drift detector configured to detect x-rays travelling along a detector axis. The spectrometer also includes an analyzer stage configured to hold a crystal analyzer that defines a Rowland circle. The analyzer stage is configured to rotate the crystal analyzer about an analyzer axis that is coplanar with the source axis and the detector axis. The spectrometer also includes an alignment apparatus comprising: a source stage that is configured to hold the source. The spectrometer also includes a detector stage that is configured to hold the detector. The spectrometer also includes a goniometer configured to (i) adjust an angle between the analyzer stage and the detector axis and (ii) adjust an angle between the analyzer stage and the source axis. The alignment apparatus is configured to move the source stage, the detector stage, and/or the analyzer stage to adjust a first distance between the source and the analyzer stage along the source axis and adjust a second distance between the detector and the analyzer stage along the detector axis.

A method for operating the spectrometer includes positioning the crystal analyzer such that a first reciprocal lattice vector corresponding to a first crystal plane of the crystal analyzer is coplanar with the source axis and the detector axis. The method further includes performing, while the first reciprocal lattice vector is coplanar with the source axis and the detector axis, a first scan by varying a first angle between the source axis and the first crystal plane and varying a second angle between the detector axis and the first crystal plane such that the first angle is substantially equal to the second angle. The method further includes rotating the crystal analyzer such that a second reciprocal lattice vector corresponding to a second crystal plane of the crystal analyzer is coplanar with the source axis and the detector axis. The method also includes performing, while the second reciprocal lattice vector is coplanar with the source axis and the detector axis, a second scan by varying the first angle and varying the second angle such that the first angle is substantially equal to the second angle.

Conventional x-ray spectrometers are generally used only in a symmetric configuration where (i) the entrance or exit slits of the source and the detector are equidistant from the crystal analyzer and (ii) and the angle formed by the source axis and the detector axis is bisected by a reciprocal lattice vector corresponding to a crystal plane that is nominally parallel to the surface of the crystal analyzer. In contrast, the first scan and/or the second scan of the aforementioned method is performed in an asymmetric configuration defined by the following conditions: (i) the entrance or exit slits of the source and the detector are not equidistant from the crystal analyzer and (ii) the angle formed by the source axis and the detector axis is bisected by a reciprocal lattice vector corresponding to a crystal plane that is not nominally parallel to the surface of the crystal analyzer.

The asymmetric configuration has at least three advantages. First, the asymmetric configuration allows the use of one crystal analyzer to investigate a sample's response within large wavelength or energy ranges. When compared to the symmetric configuration, time is saved because multiple overlapping or non-overlapping energy ranges can be investigated without removing a first crystal analyzer from an analyzer stage and inserting and calibrating a second crystal analyzer. For example, the entire energy range of 5 keV to 10 keV can be investigated simply by rotating one crystal analyzer and appropriately positioning the source and the detector prior to each new scan. Second, Johann error can be greatly reduced or eliminated because the angle between the source axis and the center surface of the crystal analyzer can be kept very high. Third, the asymmetric configuration can significantly increase the distance clearance between the source and the detector.

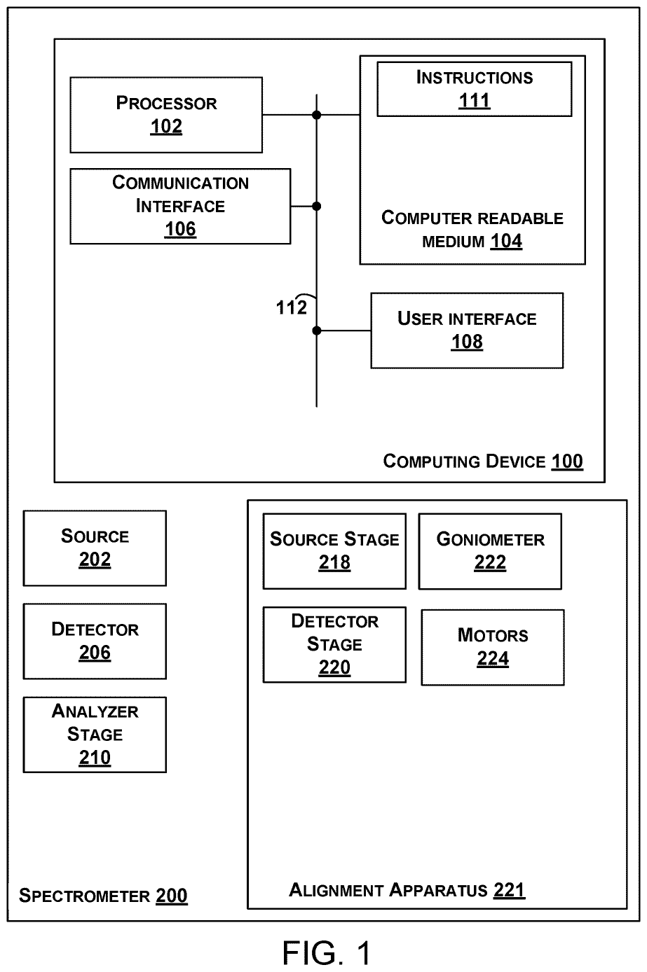

FIG. 1 is a block diagram of a spectrometer 200. The spectrometer 200 includes a computing device 100. The computing device 100 includes one or more processors 102, a non-transitory computer readable medium 104, a communication interface 106, and a user interface 108. Components of the computing device 100 are linked together by a system bus, network, or other connection mechanism 112.

The one or more processors 102 can be any type of processor(s), such as a microprocessor, a field programmable gate array, a digital signal processor, a multicore processor, etc., coupled to the non-transitory computer readable medium 104.

The non-transitory computer readable medium 104 can be any type of memory, such as volatile memory like random access memory (RAM), dynamic random access memory (DRAM), static random access memory (SRAM), or non-volatile memory like read-only memory (ROM), flash memory, magnetic or optical disks, or compact-disc read-only memory (CD-ROM), among other devices used to store data or programs on a temporary or permanent basis.

Additionally, the non-transitory computer readable medium 104 can store instructions 111. The instructions 111 are executable by the one or more processors 102 to cause the computing device 100 to perform any of the functions or methods described herein.

The communication interface 106 can include hardware to enable communication within the computing device 100 and/or between the computing device 100 and one or more other devices. The hardware can include any type of input and/or output interfaces, a universal serial bus (USB), PCI Express, transmitters, receivers, and antennas, for example. The communication interface 106 can be configured to facilitate communication with one or more other devices, in accordance with one or more wired or wireless communication protocols. For example, the communication interface 106 can be configured to facilitate wireless data communication for the computing device 100 according to one or more wireless communication standards, such as one or more Institute of Electrical and Electronics Engineers (IEEE) 801.11 standards, ZigBee standards, Bluetooth standards, etc. As another example, the communication interface 106 can be configured to facilitate wired data communication with one or more other devices. The communication interface 106 can also include analog-to-digital converters (ADCs) or digital-to-analog converters (DACs) that the computing device 100 can use to control various components of the computing device 100 or external devices.

The user interface 108 can include any type of display component configured to display data. As one example, the user interface 108 can include a touchscreen display. As another example, the user interface 108 can include a flat-panel display, such as a liquid-crystal display (LCD) or a light-emitting diode (LED) display. The user interface 108 can include one or more pieces of hardware used to provide data and control signals to the computing device 100. For instance, the user interface 108 can include a mouse or a pointing device, a keyboard or a keypad, a microphone, a touchpad, or a touchscreen, among other possible types of user input devices. Generally, the user interface 108 can enable an operator to interact with a graphical user interface (GUI) provided by the computing device 100 (e.g., displayed by the user interface 108).

The spectrometer 200 further includes a source 202, a detector 206, and an analyzer stage 210. The spectrometer 200 further includes an alignment apparatus 221 that includes a source stage 218, a detector stage 220, a goniometer 222, and one or more motors 224.

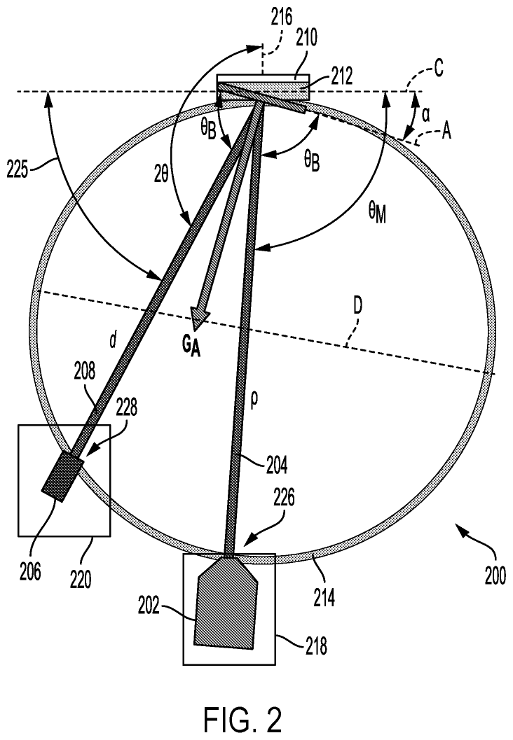

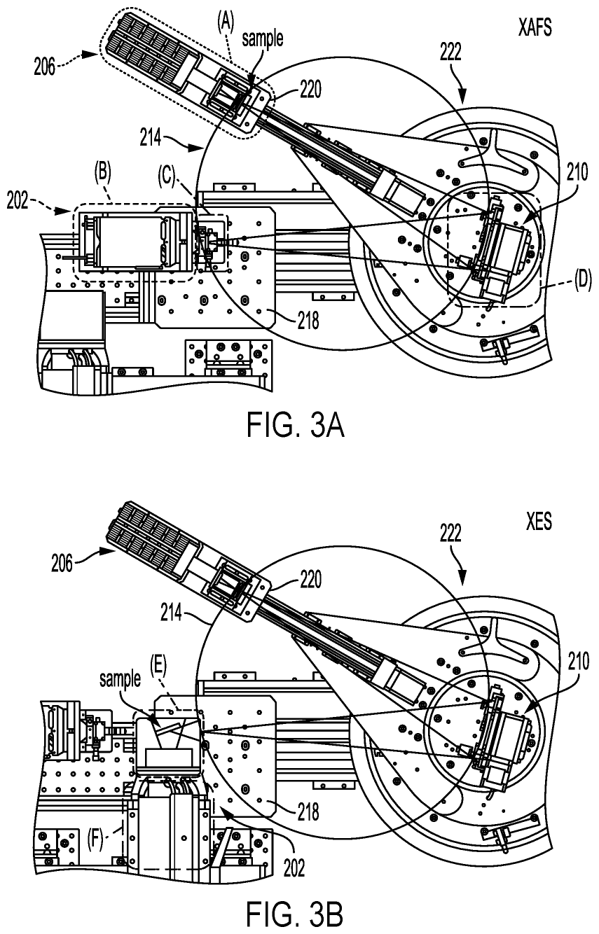

FIG. 2 is a schematic diagram of the spectrometer 200. The spectrometer 200 includes the source 202 configured to emit x-rays along a source axis 204. The x-rays emitted along the source axis 204 by the source 202 are generally divergent and not collimated, but the x-rays are typically most intense along the source axis 204. The spectrometer 200 also includes the detector 206 configured to detect x-rays travelling along a detector axis 208. The spectrometer 200 also includes the analyzer stage 210 configured to hold a crystal analyzer 212 that defines a Rowland circle 214. The analyzer stage 210 is configured to rotate the crystal analyzer 212 about an analyzer axis 216 that is coplanar with the source axis 204 and the detector axis 208. The spectrometer 200 also includes the source stage 218. In some examples, the source stage 218 is configured to move the source 202 toward or away from the analyzer stage 210 along the source axis 204. In some examples, the goniometer 222 is configured to move the analyzer stage 210 toward or away from the source 202 along the source axis 204. The spectrometer 200 also includes the detector stage 220. In some examples, the detector stage 220 is configured to move the detector 206 toward or away from the analyzer stage 210 along the detector axis 208. In some examples, the goniometer 222 is configured to move the analyzer stage 210 toward or away from the detector 206 along the detector axis 208. The spectrometer 200 also includes the two-circle goniometer 222 (shown in FIG. 3) configured to (i) adjust an angle 225 between the analyzer stage 210 and the detector axis 208 and (ii) adjust an angle θ_{M} between the analyzer stage 210 and the source axis 204. The alignment apparatus 221 (e.g., the source stage 218, the detector stage 220, the goniometer 222, and/or the one or more motors 224) is configured to move the source stage 218, the detector stage 220, and/or the analyzer stage 210 to adjust a distance p between the source 202 and the analyzer stage 210 along the source axis 204 and adjust a distance d between the detector 206 and the analyzer stage 210 along the detector axis 208.

The diameter of the Rowland circle 214 is equal to a radius of curvature of the crystal analyzer 212. The crystal analyzer 212 can take the form of a spherically bent crystal analyzer. The Rowland circle 214 is tangent to the center surface of the crystal analyzer 212.

The source 202 can take the form of an x-ray tube, a sample illuminated by an x-ray tube, or a synchrotron. In various examples, the sample under test can be located on the source stage 218 with the source 202. The source 202 includes an entrance slit 226 on the Rowland circle 214. The source stage 218 is a platform configured to secure the source 202 and prevent unintended movement of the source 202. A motor 224A is configured to move the source stage 218 back and forth along the source axis 204.

The detector 206 can take the form of a silicon drift detector and includes an exit slit 228 on the Rowland circle 214. In various examples, the sample under test can be located on the detector stage 220 with the detector 206. The detector stage 220 is a platform configured to secure the detector 206 and prevent unintended movement of the detector 206. A motor 224B is configured to move the detector stage 220 back and forth along the detector axis 208.

The analyzer stage 210 is a platform configured to secure the crystal analyzer 212 and prevent unintended movement of the crystal analyzer 212. Thus, the analyzer stage 210 can include clips under tension that hold the crystal analyzer 212 in place. A motor 224C is configured to rotate the analyzer stage 210 and the crystal analyzer 212 about the analyzer axis 216.

The goniometer 222 (shown in FIG. 3) is a mechanical apparatus configured to swivel the detector stage 220 and the source stage 218 with respect to the analyzer stage 210. One or more motors 224 are configured to operate the goniometer 222. For example, a motor 224D is configured to adjust the angle 225 and a motor 224E is configured to adjust the angle θ_{M}. In some examples, a motor 224F is configured to move the analyzer stage 210 such that the distance p is increased or reduced and a motor 224G is configured to move the analyzer stage 210 such that the distance d is increased or reduced.

FIG. 3A and FIG. 3B show the operation of the spectrometer 200 in two different modes. FIG. 3A shows the spectrometer 200 performing x-ray absorption fine structure (XAFS) spectroscopy which is a transmission mode in which the spectrometer 200 generates a tunable intensity spectrum of energies of x-rays that are transmitted through the sample. As shown, the sample is located on the detector stage 220.

FIG. 3B shows the spectrometer 200 performing x-ray emission spectroscopy (XES) which is an emission mode. As shown, the sample is located on the source stage 218. This geometry also applies when the spectrometer 200 is used to perform wavelength-dispersive x-ray fluorescence spectroscopy (WD-XRF). In various examples, the spectrometer 200 can operate in an emission mode, an absorption mode, a transmission mode, or a florescence mode. In the florescence mode, the sample is roughly on the Rowland circle 214 and the detector 206 is usually above the Rowland circle 214.

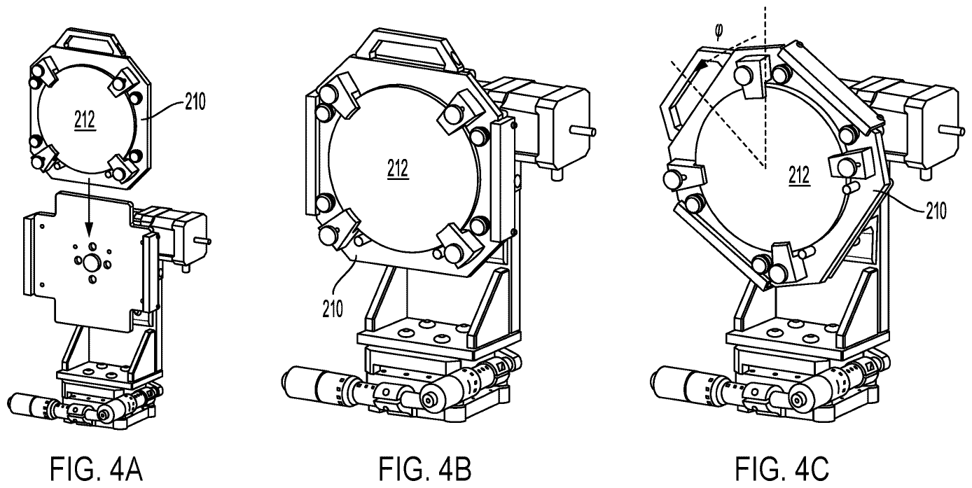

FIG. 4A, FIG. 4B, and FIG. 4C are schematic diagrams of the analyzer stage 210 and the crystal analyzer 212. The analyzer stage 210 is configured to rotate the crystal analyzer 212 about the analyzer axis 216 (see FIG. 2). Thus, the angle of rotation o defines a plane that is normal to the analyzer axis 216.

Referring to FIG. 2, the spectrometer 200 positions the crystal analyzer 212 such that a reciprocal lattice vector G_{A} corresponding to a crystal plane A of the center of the crystal analyzer 212 is coplanar with the source axis 204 and the detector axis 208. Generally, the analyzer stage 210 is rotated about the analyzer axis 216 manually or using the motor 224C such that the reciprocal lattice vector G_{A} is coplanar with the Rowland circle 214. In a particular example, the reciprocal lattice vector G_{A} is G_{5,5,1} which means that the spectrometer 200 positions the crystal analyzer 212 such that the 5,5,1 plane of the (e.g., silicon) crystal analyzer 212 is normal to the Rowland circle 214. In examples where the spectrometer 200 is operating in the symmetric configuration, the crystal plane A of the crystal analyzer 212 is nominally parallel to the center surface of the crystal analyzer 212. In other examples where the spectrometer 200 is operating in the asymmetric configuration, the crystal plane A of the crystal analyzer 212 is not nominally parallel to the center surface of the crystal analyzer 212.

Prior to and while performing a first scan, the spectrometer 200 translates the source 202 and/or the crystal analyzer 212 such that (i) the source axis 204 is coplanar with the detector axis 208 and the reciprocal lattice vector G_{A} and (ii) a source distance p between the source 202 and the crystal analyzer 212 along the source axis 204 is substantially equal to a diameter D of the Rowland circle multiplied by a sine of a sum of (a) the angle θ_{B} formed by the source axis 204 and the crystal plane A and (b) the angle α formed by the crystal plane A and a crystal plane C that is nominally parallel to a curved center surface of the crystal analyzer 212. This relationship is expressed with the following equation: ρ=D sin(θ_{B}+α). The spectrometer 200 can translate the source 202 by adjusting the placement of the source stage 218 either manually or via the motor 224A. The spectrometer 200 can translate the crystal analyzer 212 by translating the analyzer stage 210, for example using the motor 224F.

Also prior to and while performing the first scan, the spectrometer 200 translates the detector 206 and/or the crystal analyzer 212 such that (i) the detector axis 208 is coplanar with the source axis 204 and the reciprocal lattice vector G_{A} and (ii) a detector distance d between the detector 206 and the crystal analyzer 212 along the detector axis 208 is substantially equal to the diameter D of the Rowland circle 214 multiplied by a sine of a difference of (a) the angle θ_{B} formed by the detector axis 208 and the crystal plane A minus (b) the angle α formed by the crystal plane A and the crystal plane C. This relationship is expressed with the following equation: d=D sin(θ_{B}−α). The spectrometer 200 can translate the detector 206 by adjusting the placement of the detector stage 220 either manually or via the motor 224B. The spectrometer 200 can translate the crystal analyzer 212 by translating the analyzer stage 210, for example using the motor 224G.

Then, the spectrometer 200 performs the first scan while the reciprocal lattice vector G_{A} is coplanar with the source axis 204 and the detector axis 208. Performing the first scan involves the goniometer 222 varying the angle θ_{B} between the source axis 204 and the crystal plane A and varying the angle θ_{B} between the detector axis 208 and the crystal plane A. The angles θ_{B} are kept substantially equal to each other during the first scan. The first scan also involves the detector 206 detecting monochromatic x-rays from the crystal analyzer 212 while varying the angles θ_{B}.

In transmission or absorption configurations, the source 202 illuminates the crystal analyzer 212 with first x-rays such that second x-rays are emitted from the crystal analyzer 212 via Bragg reflection and incident on a sample. The detector 206 detects the second x-rays that transmit through the sample.

In emission configurations, the source 202 illuminates the sample with first x-rays such that second x-rays are emitted by the sample and incident on the crystal analyzer 212.

These x-rays may enter the Rowland circle through the entrance slit 226 on the source stage 218. Then, the detector 206 detects third x-rays that are reflected from the crystal analyzer 212 via Bragg reflection of the second x-rays.

Regardless of the configuration of the first scan, the spectrometer 200 generates a tunable intensity spectrum of energies of x-rays that are detected by the detector 206. For example, if the reciprocal lattice vector G_{A} corresponds to the 5,1,1, plane of silicon, the energy range of the first scan corresponds to approximately 8.3 keV to 9.4 keV.

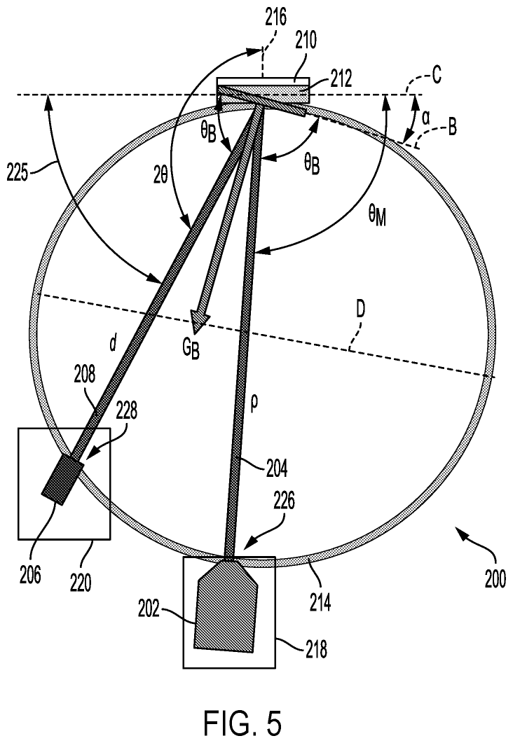

FIG. 5 shows the spectrometer 200 performing a second scan. To begin the second scan, the spectrometer 200 rotates the crystal analyzer 212 about the analyzer axis 216 such that a reciprocal lattice vector G_{B} corresponding to a crystal plane B of the center of the crystal analyzer 212 is coplanar with the source axis 204 and the detector axis 208. Generally, the analyzer stage 210 is rotated about the analyzer axis 216 manually or using the motor 224C such that the reciprocal lattice vector G_{B} is coplanar with the Rowland circle 214. In a particular example, the reciprocal lattice vector G_{B} is G_{3,5,1} which means that the spectrometer 200 positions the crystal analyzer 212 such that the 3,5,−1 plane of the center of the (e.g., silicon) crystal analyzer 212 is normal to the Rowland circle 214. In examples where the spectrometer 200 is operating in the symmetric configuration, the crystal plane B of the crystal analyzer 212 is nominally parallel to the center surface of the crystal analyzer 212. In other examples where the spectrometer 200 is operating in the asymmetric configuration, the crystal plane B of the crystal analyzer 212 is not nominally parallel to the center surface of the crystal analyzer 212.

Prior to and while performing the second scan, the spectrometer 200 translates the source 202 and/or the crystal analyzer 212 such that (i) the source axis 204 is coplanar with the detector axis 208 and the reciprocal lattice vector G_{B} and (ii) a source distance p between the source 202 and the crystal analyzer 212 along the source axis 204 is substantially equal to a diameter D of the Rowland circle multiplied by a sine of a sum of (a) the angle θ_{B} formed by the source axis 204 and the crystal plane B and (b) the angle α formed by the crystal plane B and a crystal plane C that is nominally parallel to a curved center surface of the crystal analyzer 212. This relationship is expressed with the following equation: ρ=D sin(θ_{B}+α). The spectrometer 200 can translate the source 202 by adjusting the placement of the source stage 218 either manually or via the motor 224A. The spectrometer 200 can translate the crystal analyzer 212 by translating the analyzer stage 210, for example using the motor 224F.

Also prior to and while performing the second scan, the spectrometer 200 translates the detector 206 and/or the crystal analyzer 212 such that (i) the detector axis 208 is coplanar with the source axis 204 and the reciprocal lattice vector G_{B} and (ii) a detector distance d between the detector 206 and the crystal analyzer 212 along the detector axis 208 is substantially equal to the diameter D of the Rowland circle 214 multiplied by a sine of a difference of (a) the angle θ_{B} formed by the detector axis 208 and the crystal plane B minus (b) the angle α formed by the crystal plane B and the crystal plane C. This relationship is expressed with the following equation: d=D sin(θ_{B}−α). The spectrometer 200 can translate the detector 206 by adjusting the placement of the detector stage 220 either manually or via the motor 224B. The spectrometer 200 can translate the crystal analyzer 212 by translating the analyzer stage 210, for example using the motor 224G.

Then, the spectrometer 200 performs the second scan while the reciprocal lattice vector G_{B} is coplanar with the source axis 204 and the detector axis 208. Performing the second scan involves the goniometer 222 varying the angle θ_{B} between the source axis 204 and the crystal plane B and varying the angle θ_{B} between the detector axis 208 and the crystal plane B. The angles θ_{B} are kept substantially equal to each other during the second scan. The second scan also involves the detector 206 detecting monochromatic x-rays from the crystal analyzer 212 while varying the angles θ_{B}.

In transmission or absorption configurations, the source 202 illuminates the crystal analyzer 212 with first x-rays such that second x-rays are emitted from the crystal analyzer 212 via Bragg reflection and incident on a sample. The detector 206 detects the second x-rays that transmit through the sample.

In emission configurations, the source 202 illuminates the sample with first x-rays such that second x-rays are emitted by the sample and incident on the crystal analyzer 212.

The second x-rays may enter the Rowland circle through the entrance slit 226 on the source stage 218. Then, the detector 206 detects third x-rays that are reflected from the crystal analyzer 212 via Bragg reflection of the second x-rays.

Regardless of the configuration of the second scan, the spectrometer 200 generates an intensity spectrum of energies of x-rays that are detected by the detector 206. For example, if the reciprocal lattice vector G_{B} corresponds to the 3,5,−1 plane of silicon, the energy range of the second scan corresponds to approximately 6.5 keV to 8.1 keV.

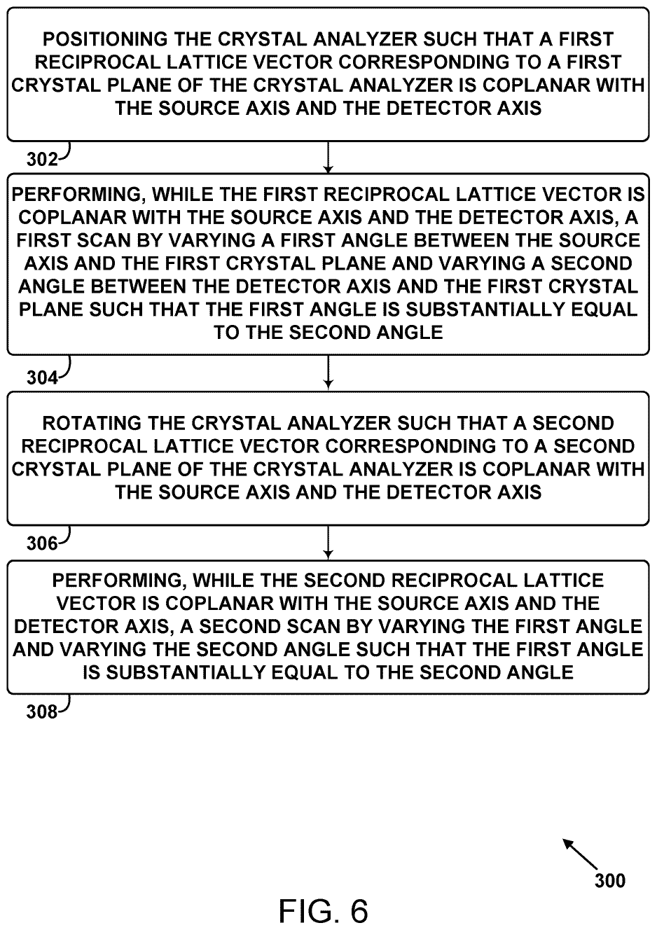

FIG. 6 is a block diagram of a method 300. As shown in FIG. 6, the method 300 includes one or more operations, functions, or actions as illustrated by blocks 302, 304, 306, and 308. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 302, the method 300 includes the spectrometer 200 or a user positioning the crystal analyzer 212 such that the reciprocal lattice vector G_{A} corresponding to the crystal plane A of the crystal analyzer 212 is coplanar with the source axis 204 and the detector axis 208. Functionality related to block 302 is discussed above with reference to FIGS. 2-4.

At block 304, the method 300 includes the spectrometer 200, while the reciprocal lattice vector G_{A} is coplanar with the source axis 204 and the detector axis 208, performing a first scan by varying the angle θ_{B} between the source axis 204 and the crystal plane A and varying the angle θ_{B} between the detector axis 208 and the crystal plane A such that the angle θ_{B} between the source axis 204 and the crystal plane A is substantially equal to the angle θ_{B} between the detector axis 208 and the crystal plane A. Functionality related to block 304 is discussed above with reference to FIGS. 2-4.

At block 306, the method 300 includes the spectrometer 200 or a user rotating the crystal analyzer 212 such that the reciprocal lattice vector G_{B} corresponding to the crystal plane B of the crystal analyzer 212 is coplanar with the source axis 204 and the detector axis 208. Functionality related to block 306 is discussed above with reference to FIGS. 2-5.

At block 308, the method 300 includes the spectrometer 200 performing, while the reciprocal lattice vector G_{B} is coplanar with the source axis 204 and the detector axis 208, a second scan by varying the angle θ_{B} between the source axis 204 and the crystal plane B and varying the angle θ_{B} between the detector axis 208 and the crystal plane B such that the angle θ_{B} between the source axis 204 and the crystal plane B is substantially equal to the angle θ_{B} between the detector axis 208 and the crystal plane B. Functionality related to block 304 is discussed above with reference to FIGS. 3-5.

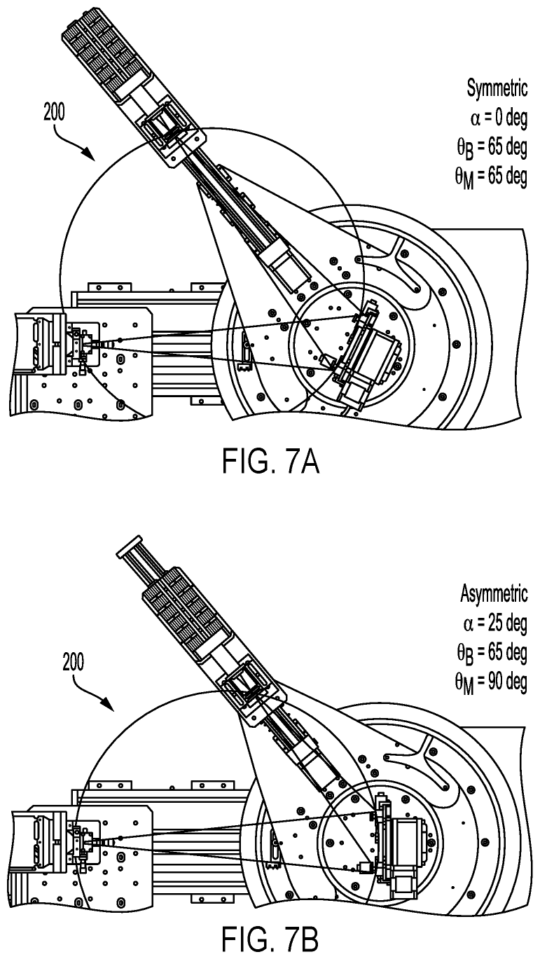

FIG. 7A shows the spectrometer 200 configured for conducting XAFS in a symmetric configuration. In the symmetric configuration, the Bragg angle θ_{B} is equal to the angle θ_{M} between the source axis 204 and the crystal plane C that is nominally parallel to the center surface of the crystal analyzer 212.

FIG. 7B shows the spectrometer 200 configured for conducting XAFS in an asymmetric configuration. In the asymmetric configuration, the Bragg angle θ_{B} is not equal to the angle θ_{M}. The asymmetric configuration allows for a Bragg angle such as 65° while the x-rays from the source 202 are incident on the crystal analyzer 212 at a high angle such as 90°. This high angle of incidence on the crystal analyzer 212 can yield high signal intensity combined with reduced or eliminated Johann error despite the use of Bragg angles much less than 90 degrees.

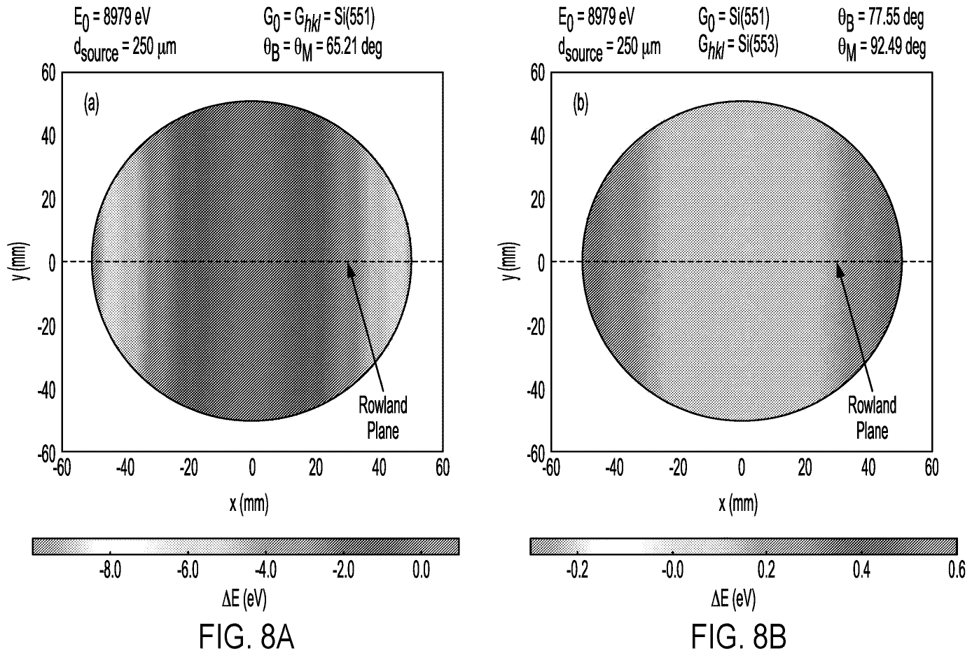

FIG. 8A shows the significant Johann error that occurs for x-rays incident on a crystal analyzer more than about 10 mm off center when operating in the symmetric configuration.

FIG. 8B shows that Johann error is close to zero for x-rays incident on the crystal analyzer less than about 40 mm off center when operating in the asymmetric configuration.

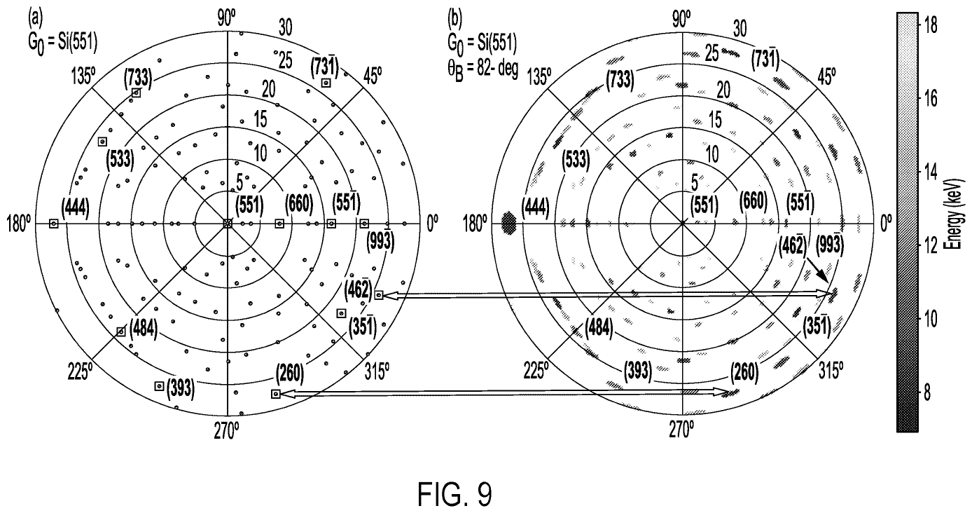

FIG. 9 shows calculated values and experimental results for (α, φ) corresponding to several crystal planes of the Si(551) crystal analyzer. The asymmetry angle α corresponds to the radial direction and the rotation angle φ corresponds to the azimuthal direction. For example, the 733 crystal plane of the Si(551) crystal analyzer corresponds to approximately α=25° and φ=120°.

While various example aspects and example embodiments have been disclosed herein, other aspects and embodiments will be apparent to those skilled in the art. The various example aspects and example embodiments disclosed herein are for purposes of illustration and are not intended to be limiting, with the true scope and spirit being indicated by the following claims.

1. A method of operating a spectrometer comprising a crystal analyzer that defines a Rowland circle, a source configured to emit x-rays along a source axis, and a detector configured to detect x-rays travelling along a detector axis, the method comprising:
positioning the crystal analyzer such that a first reciprocal lattice vector corresponding to a first crystal plane of the crystal analyzer is coplanar with the source axis and the detector axis;
performing, while the first reciprocal lattice vector is coplanar with the source axis and the detector axis, a first scan by varying a first angle between the source axis and the first crystal plane and varying a second angle between the detector axis and the first crystal plane such that the first angle is substantially equal to the second angle;
rotating the crystal analyzer such that a second reciprocal lattice vector corresponding to a second crystal plane of the crystal analyzer is coplanar with the source axis and the detector axis; and
performing, while the second reciprocal lattice vector is coplanar with the source axis and the detector axis, a second scan by varying the first angle and varying the second angle such that the first angle is substantially equal to the second angle.

2-4. (canceled)

5. The method of claim 1, wherein performing the first scan further comprises:
illuminating a sample with first x-rays using the source such that second x-rays are emitted by the sample and incident on the crystal analyzer; and
detecting, using the detector, third x-rays that are reflected from the crystal analyzer via Bragg reflection of the second x-rays.

6. The method of claim 5, wherein performing the first scan and performing the second scan each comprises performing x-ray emission spectroscopy (XES).

7. The method of claim 5, wherein performing the first scan and performing the second scan each comprises performing wavelength-dispersive x-ray fluorescence spectroscopy (WD-XRF).

8. The method of claim 1, wherein performing the first scan further comprises:
illuminating the crystal analyzer with first x-rays using the source such that second x-rays are emitted from the crystal analyzer via Bragg reflection and incident on a sample; and
detecting, using the detector, the second x-rays that transmit through the sample.

9. The method of claim 8, wherein performing the first scan and performing the second scan each comprises performing x-ray absorption fine structure (XAFS) analysis.

10-11. (canceled)

12. The method of claim 1 wherein performing the first scan comprises translating the source and/or the crystal analyzer such that (i) the source axis is coplanar with the detector axis and the first reciprocal lattice vector and (ii) a source distance between the source and the crystal analyzer along the source axis is substantially equal to a diameter of the Rowland circle multiplied by a sine of a sum of (a) the first angle and (b) a third angle formed by the first crystal plane and a third crystal plane that is nominally parallel to a curved surface of the crystal analyzer.

13. The method of claim 12, wherein performing the second scan comprises translating the source and/or the crystal analyzer such that (i) the source axis is coplanar with the detector axis and the second reciprocal lattice vector and (ii) the source distance is substantially equal to the diameter of the Rowland circle multiplied by a sine of a second sum of (a) the first angle and (b) a fourth angle formed by the second crystal plane and the third crystal plane.

14. The method of claim 1, wherein performing the first scan comprises translating the detector and/or the crystal analyzer such that (i) the detector axis is coplanar with the source axis and the first reciprocal lattice vector and (ii) a detector distance between the detector and the crystal analyzer along the detector axis is substantially equal to a diameter of the Rowland circle multiplied by a sine of a difference of (a) the first angle minus (b) a third angle formed by the first crystal plane and a third crystal plane that is nominally parallel to a curved surface of the crystal analyzer.

15. The method of claim 14, wherein performing the second scan comprises translating the detector and/or the crystal analyzer such that (i) the detector axis is coplanar with the source axis and the second reciprocal lattice vector and (ii) the detector distance is substantially equal to the diameter of the Rowland circle multiplied by a sine of a second difference of (a) the first angle minus (b) a fourth angle formed by the second crystal plane and the third crystal plane.

16-17. (canceled)

18. The method of claim 1, wherein positioning the crystal analyzer such that the first reciprocal lattice vector is coplanar with the source axis and the detector axis comprises rotating the crystal analyzer about a rotation axis that is coplanar with the source axis and the detector axis.

19. The method of claim 1, wherein performing the first scan comprises detecting x-rays within a first energy range, and performing the second scan comprises detecting x-rays within a second energy range that does not overlap with the first energy range.

20-21. (canceled)

22. The method of claim 1, wherein rotating the crystal analyzer such that the second reciprocal lattice vector is coplanar with the source axis and the detector axis comprises rotating the crystal analyzer about a rotation axis that is coplanar with the source axis and the detector axis.

23-24. (canceled)

25. A spectrometer comprising:
a source configured to emit x-rays along a source axis;
a detector configured to detect x-rays travelling along a detector axis;
an analyzer stage configured to hold a crystal analyzer that defines a Rowland circle, wherein the analyzer stage is configured to rotate the crystal analyzer about an analyzer axis that is coplanar with the source axis and the detector axis; and
an alignment apparatus comprising:
a source stage that is configured to hold the source;
a detector stage that is configured to hold the detector; and
a goniometer configured to (i) adjust a first angle between the analyzer stage and the detector axis and (ii) adjust a second angle between the analyzer stage and the source axis, wherein the alignment apparatus is configured to move the source stage, the detector stage, and/or the analyzer stage to adjust a first distance between the source and the analyzer stage along the source axis and adjust a second distance between the detector and the analyzer stage along the detector axis.

26. (canceled)

27. The spectrometer of claim 25, the alignment apparatus further comprising:
a first motor configured to move the source stage along the source axis; or
a second motor configured to move the detector stage along the detector axis.

28. (canceled)

29. The spectrometer of claim 25, the goniometer comprising one or more motors configured to adjust the first angle and the sixth second angle.

30. The spectrometer of claim 25, the alignment apparatus comprising a third motor configured to move the analyzer stage along the source axis.

31. The spectrometer of claim 25, the alignment apparatus comprising a fourth motor configured to move the analyzer stage along the detector axis.

32. The spectrometer of claim 25, further comprising a fifth motor configured to rotate the analyzer stage about the analyzer axis.

33-39. (canceled)

40. A non-transitory computer readable medium storing instructions that, when executed by one or more processors of a spectrometer comprising a crystal analyzer that defines a Rowland circle, a source configured to emit x-rays along a source axis, and a detector configured to detect x-rays travelling along a detector axis, cause the spectrometer to perform functions comprising:
positioning the crystal analyzer such that a first reciprocal lattice vector corresponding to a first crystal plane of the crystal analyzer is coplanar with the source axis and the detector axis;
performing, while the first reciprocal lattice vector is coplanar with the source axis and the detector axis, a first scan by varying a first angle between the source axis and the first crystal plane and varying a second angle between the detector axis and the first crystal plane such that the first angle is substantially equal to the second angle; rotating the crystal analyzer such that a second reciprocal lattice vector corresponding to a second crystal plane of the crystal analyzer is coplanar with the source axis and the detector axis; and
performing, while the second reciprocal lattice vector is coplanar with the source axis and the detector axis, a second scan by varying the first angle and varying the second angle such that the first angle is substantially equal to the second angle.
